(19) United States
(12) Patent Application Publication
(10) Pub. No.: US 2024/0334100 A1
(43) Pub. Date: Oct. 3, 2024

(54) SOUND REPRODUCTION APPARATUS

(71) Applicant: SONY GROUP CORPORATION, TOKYO (JP)

(72) Inventors: TERUTAKA YANA, TOKYO (JP); TOMOHIRO YOKOYAMA, TOKYO (JP); KOJI MIURA, TOKYO (JP)

(21) Appl. No.: 18/575,950

(22) PCT Filed: Mar. 2, 2022
(86) PCT No.: PCT/JP2022/008815

§ 371 Date: Jan. 2, 2024

(30) Foreign Application Priority Data
Jul. 15, 2021 (JP) 2021-116841

(51) Int. Cl. H04R 1/02

(52) U.S. Cl. CPC H04R 1/02

(57) ABSTRACT

For example, the level of direct sound leaking is reduced.

A sound reproduction apparatus includes: a speaker unit; and a hollow sound conduit having one end side closed and another end side serving as an open end fitted with the speaker unit, in which the sound conduit has a plurality of holes, and the holes each have a shape inclined in a beam generation direction of sound radiated through the plurality of holes.

### TECHNICAL FIELD

The present disclosure relates to a sound reproduction apparatus.

### BACKGROUND ART

There is known a sound reproduction apparatus in which an opening is provided in a cylindrical sound conduit and sound is reproduced through the opening (see, for example, Patent Document 1). Such a sound reproduction apparatus can be used as an auxiliary speaker that exerts an effect of creating a feeling of an extensive sound field with a reflected sound generated from sound which is reproduced from the sound reproduction apparatus and is reflected on a ceiling or walls in a sound reproduction space (hereinafter referred to as a reflection effect as appropriate). The greater the sound pressure level of the reflected sound, the more readily the reflection effect can be achieved.

### CITATION LIST

### Patent Document

Patent Document 1: Japanese Unexamined Patent Application Publication No. 2011-520354

### SUMMARY OF THE INVENTION

### Problems to be Solved by the Invention

Not a little sound leaks through the opening of the sound reproduction apparatus also in the opening direction. The leaked sound directly transmitted to a user (hereinafter, also referred to as direct sound as appropriate) reduces the reflection effect. Therefore, it is desirable to improve the reflection effect by reducing the sound pressure level of the direct sound so as to relatively increase the sound pressure level of the reflected sound, or by directly increasing the sound pressure level of the reflected sound.

An object of the present disclosure is to provide a sound reproduction apparatus having a configuration to reduce a sound pressure level of direct sound.

### Solutions to Problems

The present disclosure provides, for example, a sound reproduction apparatus including:
a speaker unit; and
a hollow sound conduit having one end side closed and another end side serving as an open end fitted with the speaker unit, in which
the sound conduit has a plurality of holes, and
the holes each have a shape inclined in a beam generation direction of sound radiated through the plurality of holes.

### BRIEF DESCRIPTION OF DRAWINGS

FIG. 1A is a perspective view of a sound reproduction apparatus according to one embodiment, and FIG. 1B is a half cross-sectional view of the sound reproduction apparatus according to the embodiment.

FIGS. 2A and 2B are diagrams illustrating a state in which the sound reproduction apparatus according to the embodiment is horizontally placed.

FIG. 3 is a diagram for describing details of holes according to the embodiment.

FIG. 4 is a diagram to be referred to when the inclination of the holes according to the embodiment is described.

FIG. 5 is a diagram to be referred to when the inclination of the holes according to the embodiment is described.

FIG. 6 is a diagram to be referred to when the inclination of general holes is described.

FIG. 7 is a diagram to be referred to when the inclination of the holes according to the embodiment is described.

FIG. 8 is a diagram for describing functions of the holes according to the embodiment.

FIG. 9 is a diagram for describing an example of an effect achieved by the embodiment.

FIG. 10 is a diagram for describing an example of an effect achieved by the embodiment.

FIG. 11A and FIG. 11B are views for illustrating a usage example of the sound reproduction apparatus according to the embodiment.

### MODE FOR CARRYING OUT THE INVENTION

Embodiments and the like of the present disclosure will be described below with reference to the drawings. Note that the description will be made in the following order.

### One Embodiment

### Modified Examples

The embodiment and the like to be described hereinafter are preferred specific examples of the present disclosure, and the content of the present disclosure is not limited to the embodiment and the like.

Note that, unless otherwise specified, the description and the like of dimensions, materials, shapes, relative arrangements, and directions such as top, bottom, left, and right of constituent members described in the embodiment are given as an example and not as a limitation of the scope of the present disclosure. Note that the sizes, the positional relationships of the members, and the like in each of the drawings may be exaggerated for clarity of description, and furthermore, there may be a case where only some of reference numerals are illustrated or the illustration is partially simplified in order to prevent the illustration from becoming complicated. Furthermore, in the description below, the same designations or the same reference numerals denote the same or similar members, and redundant descriptions will be omitted as appropriate.

### One Embodiment

### [Configuration Example of Sound Reproduction Apparatus] (Overall Configuration Example)

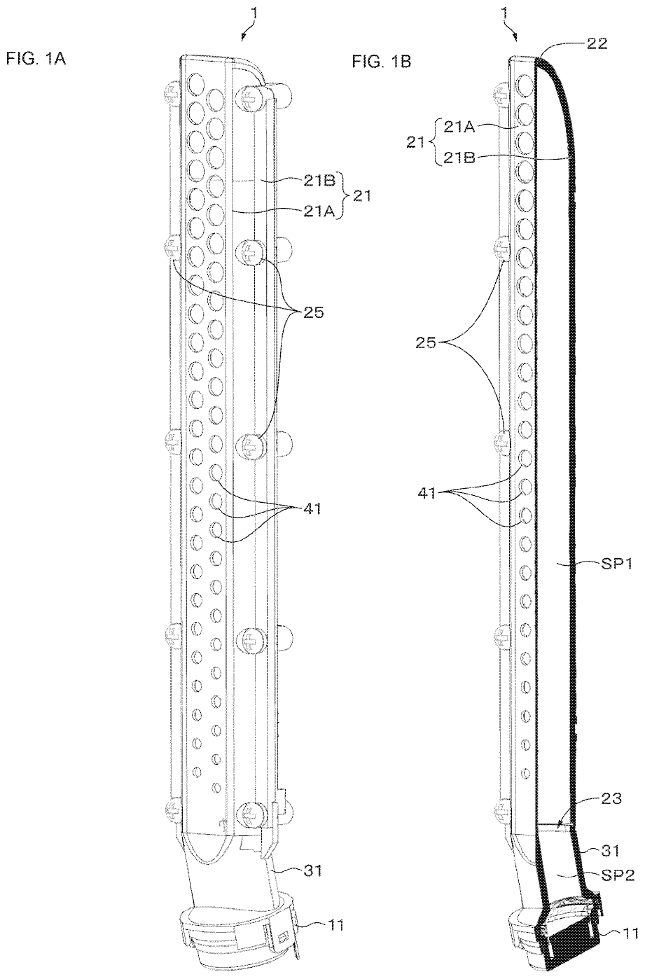

FIG. 1A is a perspective view of a sound reproduction apparatus according to the present embodiment (sound reproduction apparatus 1), and FIG. 1B is a half cross-sectional view of the sound reproduction apparatus 1 according to the present embodiment. The sound reproduction apparatus 1 according to the present embodiment is used as a reproduction apparatus that achieves the above-described reflection effect by using reflected sound.

The sound reproduction apparatus 1 generally includes a speaker unit 11, a sound conduit 21 having a tubular shape (cylindrical shape), and a connecting portion 31.

The speaker unit 11 is a tweeter unit that reproduces sound in a high frequency range of a predetermined frequency or more. The sound in the high frequency range of the predetermined frequency or more includes, for example, a sound of 5 kHz or more. A signal passed through a high-pass filter having a cutoff frequency of 5 kHz by an audio processor (not illustrated) is provided to the speaker unit 11 and reproduced. Note that a speaker unit that reproduces a middle-range sound or a woofer unit that reproduces a low-range sound may be employed as the speaker unit 11. The source for the speaker unit 11 may be supplied via a wire such as a cable or may be supplied via radio such as Bluetooth (registered trademark).

The sound conduit 21 is a hollow sound conduit in which an internal space SP1 is formed, and contains resin or metal. The sound conduit 21 includes, for example, a plate-shaped portion 21A having a thin plate shape and a wall portion 21B. One end side of the wall portion 21B is slightly curved. The plate-shaped portion 21A and the wall portion 21B are integrated by screwing a plurality of screws 25. The plate-shaped portion 21A and the wall portion 21B may be integrated by adhesion or the like. By integrating the plate-shaped portion 21A and the wall portion 21B, a distal end portion 22 (an example of the one end side) of the sound conduit 21 is closed, and an open end 23 is formed on the side opposite to the distal end side. In addition, the plate-shaped portion 21A and the wall portion 21B integrated together form an internal space SP1 surrounded by the plate-shaped portion 21A and the wall portion 21B. The thickness of the plate-shaped portion 21A and the wall portion 21B is, for example, approximately 1 mm.

In addition, a plurality of holes 41 that opens into the internal space SP1 is formed in the plate-shaped portion 21A. Each of the holes 41 has, for example, a substantially circular shape, but may have another shape such as a rectangular shape. Details of the holes 41 will be described later.

The connecting portion 31 is a member that connects the speaker unit 11 and the sound conduit 21, and contains resin or metal. In addition, the connecting portion 31 is a hollow member having an internal space SP2 therein. As shown in FIG. 1B, the internal space SP2 of the connecting portion 31 communicates with the internal space SP1 via the open end 23 of the sound conduit 21. The connecting portion 31 may be movable via a hinge or the like, and the direction of the sound conduit 21 may be variable according to the movement of the connecting portion 31.

As illustrated in FIG. 1B, the speaker unit 11 is fitted with the connecting portion 31 so that the sound radiation direction is the internal spaces SP1 and SP2. In the sound reproduction apparatus 1 having such a configuration, the sound radiated from the speaker unit 11 propagates through the internal space SP2 and the internal space SP1. That is, the sound propagates inside the sound conduit 21. The sound propagating inside the sound conduit 21 is reproduced to the outside through a hole provided in the sound conduit 21, that is, through the holes 41 provided in the plate-shaped portion 21A in the present embodiment. The sound reproduced from the sound reproduction apparatus 1 may be any sound such as music, human voice, or environmental sound.

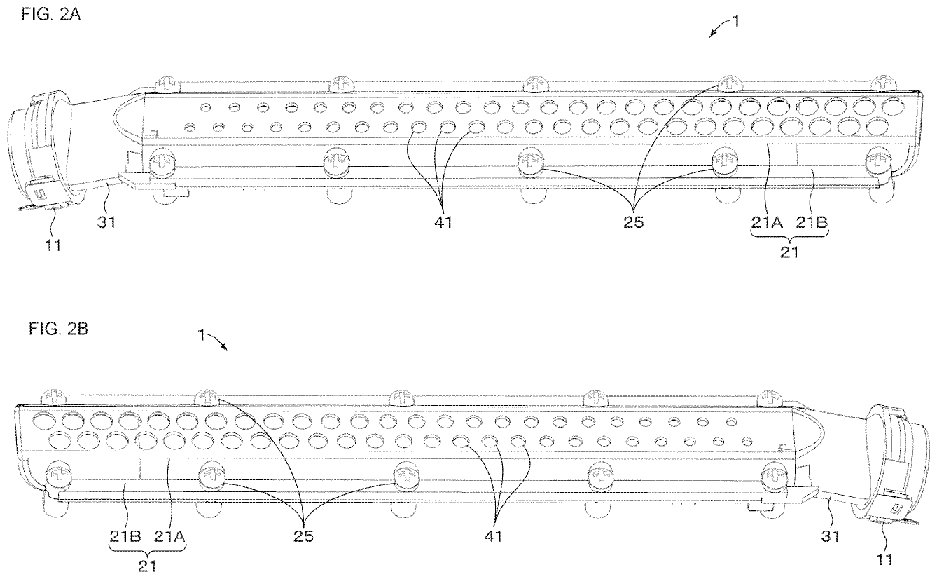

Note that the sound reproduction apparatus 1 can be used by being placed in the vertical direction (with the plurality of holes 41 arranged in the vertical direction) as illustrated in FIGS. 1A and 1B, or can be used by being placed in the horizontal direction (with the plurality of holes 41 arranged in the horizontal direction) as illustrated in FIGS. 2A and 2B. In the case of being placed in the horizontal direction, it is also possible to use the speaker unit 11 with the position thereof reversed as illustrated in FIGS. 2A and 2B.

### (Configuration Example of Holes)

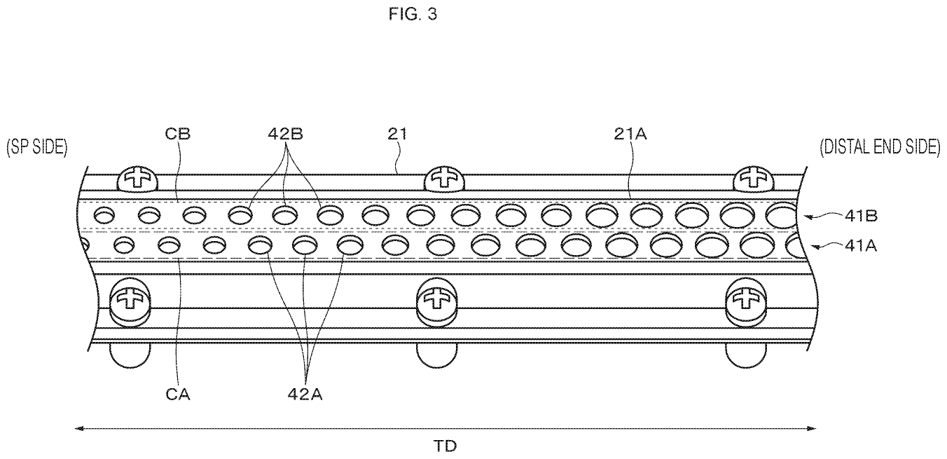

Next, details of the plurality of holes 41 provided in the plate-shaped portion 21A will be described. As illustrated in FIG. 3, the holes 41 are provided so as to be substantially aligned along an extending direction TD of the sound conduit 21 (the longitudinal direction of the plate-shaped portion 21A).

In the present embodiment, the plurality of holes 41 includes a first hole group 41A provided so as to be substantially aligned with a first row CA along the extending direction TD of the sound conduit 21 and a second hole group 41B provided so as to be substantially aligned with a second row CB along the extending direction TD of the sound conduit 21. The first row CA and the second row CB are substantially parallel rows along the extending direction TD of the sound conduit 21, and are adjacent rows. Note that the first row CA and the second row CB have a configuration in consideration of convenience of description, and the first row CA and the second row CB are not necessarily visible.

Individual holes 42A constituting the first hole group 41A are provided at substantially equal intervals. In addition, individual holes 42B constituting the second hole group 41B are also provided at substantially equal intervals. The holes 42A and the holes 42B are arranged in a staggered manner.

Furthermore, the diameter of each of the plurality of holes 42A gradually increases from the side close to the speaker unit 11 (hereinafter referred to as an SP side as appropriate) toward the side of the distal end portion 22 (hereinafter referred to as a distal end side as appropriate). With such a configuration, the respective holes can exhibit uniform radiation sound pressures as much as possible, and hence the directions of radiation obtained by combining the radiation sound pressures (beam directions) can be aligned (as a result, enhanced). Similarly, the diameter of each of the plurality of holes 42B gradually increases from the SP side toward the distal end side. With this configuration, effects similar to the effects described above can be obtained.

In addition, it is possible to generate a beam of sound over a higher frequency band as the interval between the holes becomes shorter. In a configuration in which a plurality of holes is arranged in a single row, there is a limit to shortening the interval between the holes due to restrictions on the diameter of the hole, spatial restrictions in the plate-shaped portion 21A, and restrictions in view of a manufacturing process. In contrast, the holes 42A and the holes 42B provided in the respective rows are arranged in a staggered manner according to the present embodiment, as described above. With this arrangement, the distance between the holes (for example, the distance between the centers of the holes) can be made approximately ½ as viewed in the horizontal direction (for example, in the direction toward the side surface in the longitudinal direction of the plate-shaped portion 21A), since the holes 42A and the holes 42B are alternately arranged. That is, the apparent interval between the holes can be shortened, and a beam of sound over a high frequency band can be generated.

### (Inclination of Holes)

The holes 42A and 42B according to the present embodiment have shapes inclined in a beam generation direction of sound radiated through the holes 42A and 42B of the sound conduit 21. This point will be described in detail.

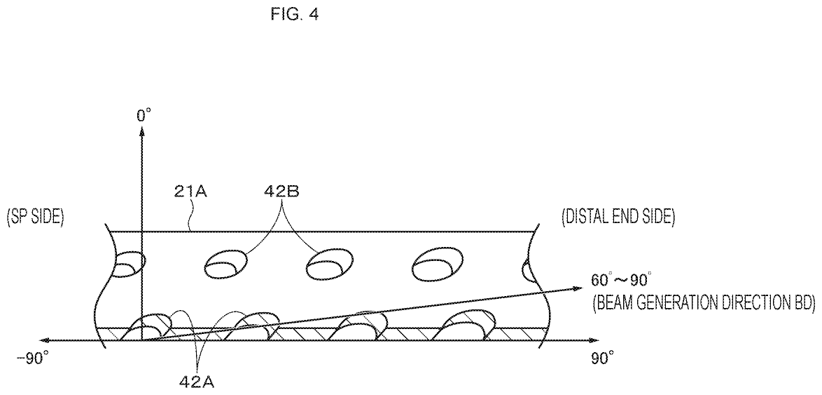

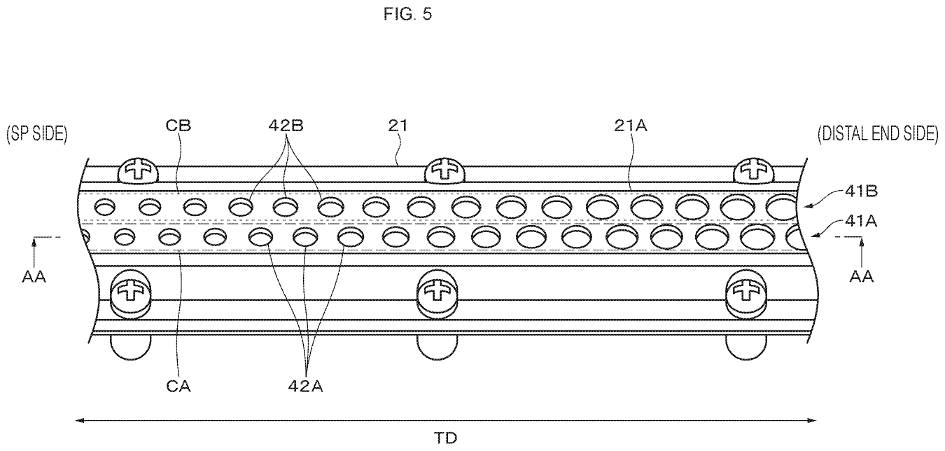

First, an angle is defined as illustrated in FIG. 4. Note that FIG. 4 is a view illustrating a part of a cross section of the plate-shaped portion 21A taken along a cutting line AA-AA illustrated in FIG. 5. As shown in FIG. 4, a direction substantially orthogonal to the plate-shaped portion 21A is defined as 0°, an extending direction of the plate-shaped portion 21A toward the SP side is defined as −90°, and an extending direction of the plate-shaped portion 21A toward the distal end side is defined as 90°.

In general, it is known that an apparatus that reproduces sound through an opening provided in a cylindrical sound conduit, such as the sound reproduction apparatus 1, has the following characteristics.
(1) If the sound wave passes along a sound conduit provided with holes, each hole behaves individually.
(2) The sound output through each hole has a time delay.
(3) By synthesizing the radiation sound pressures from all the holes, characteristics of a system can be predicted.

Such characteristics also apply to the sound reproduction apparatus 1. When the radiation sound pressures from all the holes 42A and 42B are synthesized, the sound pressure in the direction of from 60° to 90° is the largest (the sound pressure in the direction of 75° is the largest, and the sound pressure is large in the range of ±15°). The direction in which the sound pressure is large is referred to as a beam generation direction BD as appropriate.

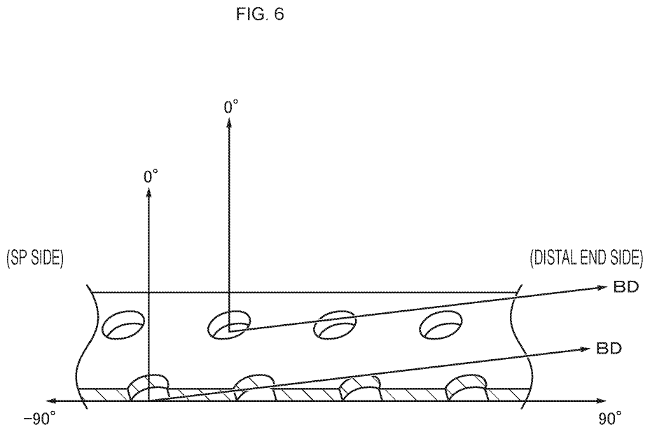

FIG. 6 illustrates a configuration example of a general sound reproduction apparatus having the above-described characteristics. A general sound reproduction apparatus has a configuration in which each hole is not inclined in the beam generation direction BD, and sound is radiated in a direction of approximately 0° (opening direction). As described above, a general sound reproduction apparatus has a configuration in which a direct sound leaking through holes in a direction of approximately 0° readily reaches a listener in a sound radiation direction.

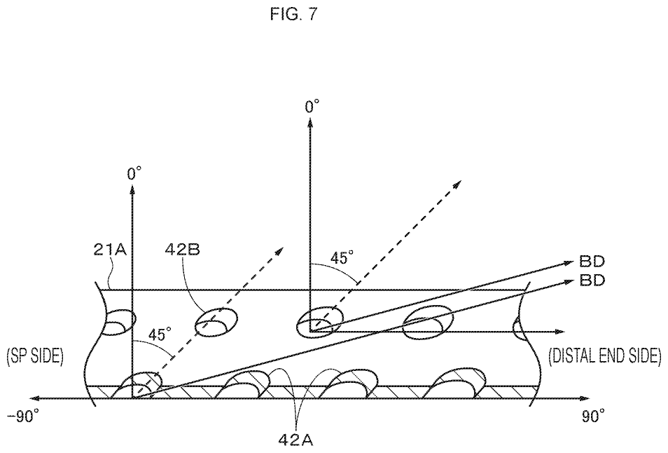

In contrast, all of the holes 42A are inclined in the beam generation direction BD in the present embodiment, as illustrated in FIG. 7. Considering the ease of forming the holes 42A in the manufacturing process and the like, the holes 42A are preferably inclined by approximately 45°. In addition, all of the holes 42B are also inclined in the beam generation direction BD, as illustrated in FIG. 7. For a reason similar to that regarding the holes 42A, the holes 42B are preferably inclined by approximately 45°.

### [Functions]

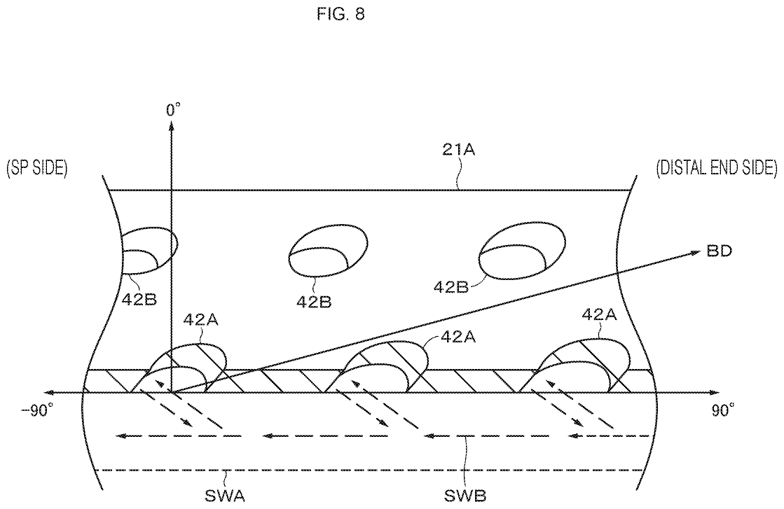

With reference to FIG. 8, functions of the holes 42A and the holes 42B having the above-described inclination (taper) will be described. Arrows illustrated on the lower side of the plate-shaped portion 21A as viewed in the direction toward the drawing plane of FIG. 8 schematically illustrate sound waves reproduced from the speaker unit 11 and propagating inside the sound conduit 21. More specifically, an arrow SWA indicates the traveling direction of the sound wave reproduced from the speaker unit 11 and traveling toward the distal end portion 22, and arrows SWB indicate the traveling direction of the sound wave reflected by the distal end portion 22. Note that the description below of the holes 42A as an example is also applicable to the holes 42B.

As illustrated in FIG. 8, the sound wave of the sound reproduced from the speaker unit 11 is radiated through the holes 42A and reproduced. At this time, since the holes 42A are inclined in the beam generation direction BD, the sound wave radiated in the 0° direction can be reduced. That is, the sound pressure level of direct sound directly leaking to a listener can be reduced. In addition, since the holes 42A are inclined in the beam generation direction BD, the sound pressure level of the sound directed in the beam generation direction BD can be improved. With this configuration, the sound pressure level of the reflected sound can be increased. Furthermore, with the configuration in which the holes 42A are inclined in the beam generation direction BD, the holes 42A each serve as a wall facing the inside of the sound conduit 21 against the traveling direction of the reflected wave (arrows SWB). With this configuration, the reflected wave can be prevented from leaking to the outside of the sound conduit 21, and hence the sound quality can be improved.

### [Effects]

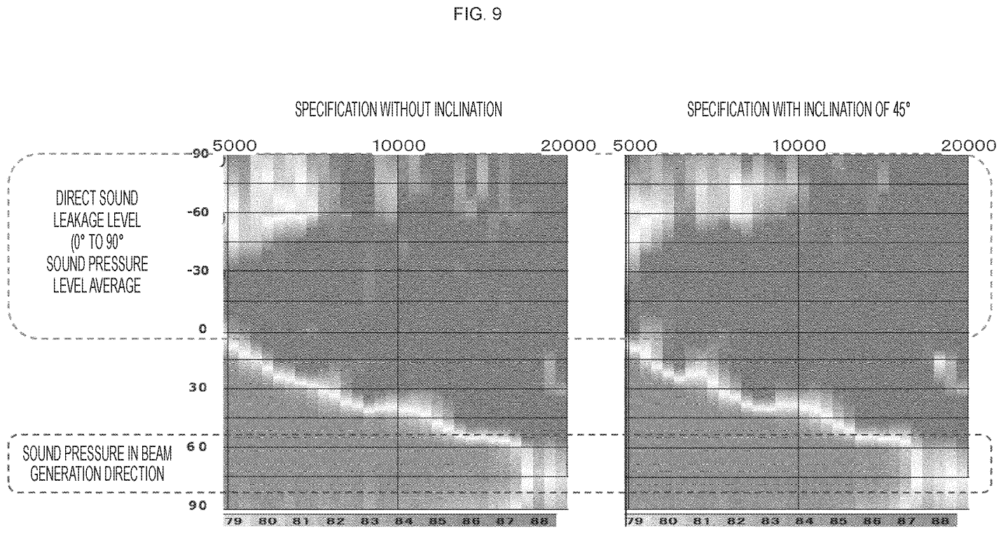

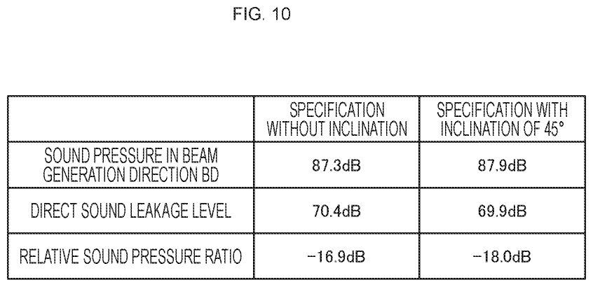

Next, an example of effects achieved by the present embodiment will be described with reference to FIGS. 9 and 10.

FIG. 9 is a contour diagram (sound pressure distribution) illustrating a result of comparison between a specification in which no inclination is provided to the holes 42A and 42B and a specification in which an inclination of 45° is provided to the holes 42A and 42B. The vertical axis of the contour diagram illustrated in FIG. 9 indicates the angle defined as illustrated in FIG. 6. The horizontal axis indicates the frequency, including a band from 5 kHz to 20 kHz which the tweeter can reproduce. The sound pressure level distribution is indicated by shading on the map defined by the angle and the frequency. The darker the shade, the higher the sound pressure level.

An average for the sound pressure level measured from 0° to −90° (for example, the sound pressure levels measured every 15°) was taken as a direct sound leakage level. The direct sound means sound that directly reaches a listener from the sound reproduction apparatus 1, which causes reduction in the reflection effect. FIG. 9 also illustrates the sound pressure level in the beam generation direction BD (60° to 90°). For example, an average for the sound pressure level measured from 60° to 90° (for example, the sound pressure levels measured every 15°) was taken as a sound pressure level in the beam generation direction BD. The difference between the direct sound leakage level and the sound pressure level in the beam generation direction BD was obtained as a relative sound pressure ratio.

As illustrated in FIG. 9, the shade exhibiting the direct sound leakage level is lighter in the specification with the inclination of the holes 42A and 42B than in the specification without the inclination, and hence it can be seen that the direct sound leakage level is lower in the specification with the inclination. In addition, the shade exhibiting the sound pressure level in the beam generation direction BD is darker in the specification with the inclination of the holes 42A and 42B than in the specification without the inclination, and hence it can be seen that the sound pressure level in the beam generation direction BD is higher in the specification with the inclination.

FIG. 10 is a graph obtained by quantifying the result in FIG. 9. The sound pressure level in the beam generation direction BD was “87.3 dB” in the specification without the inclination of the holes 42A and 42B, and was “87.9 dB” in the specification with the inclination of the holes 42A and 42B. The direct sound leakage level was “70.4 dB” in the specification without the inclination of the holes 42A and 42B, and was “69.9 dB” in the specification with the inclination of the holes 42A and 42B. The relative sound pressure ratio was “−16.9 dB” in the specification without the inclination of the holes 42A and 42B, and was “−18.0 dB” in the specification with the inclination of the holes 42A and 42B. This result shows that, in the specification in which the holes 42A and 42B are inclined, the sound pressure level in the beam generation direction BD can be increased and thus the sound pressure of the reflected sound can be increased, and therefore the reflection effect can be improved. In addition, in the specification in which the holes 42A and 42B are inclined, the leakage level of the direct sound can be reduced and the sound pressure level of the reflected sound can be relatively increased, and therefore the reflection effect can be improved.

### [Usage Example of Sound Reproduction Apparatus]

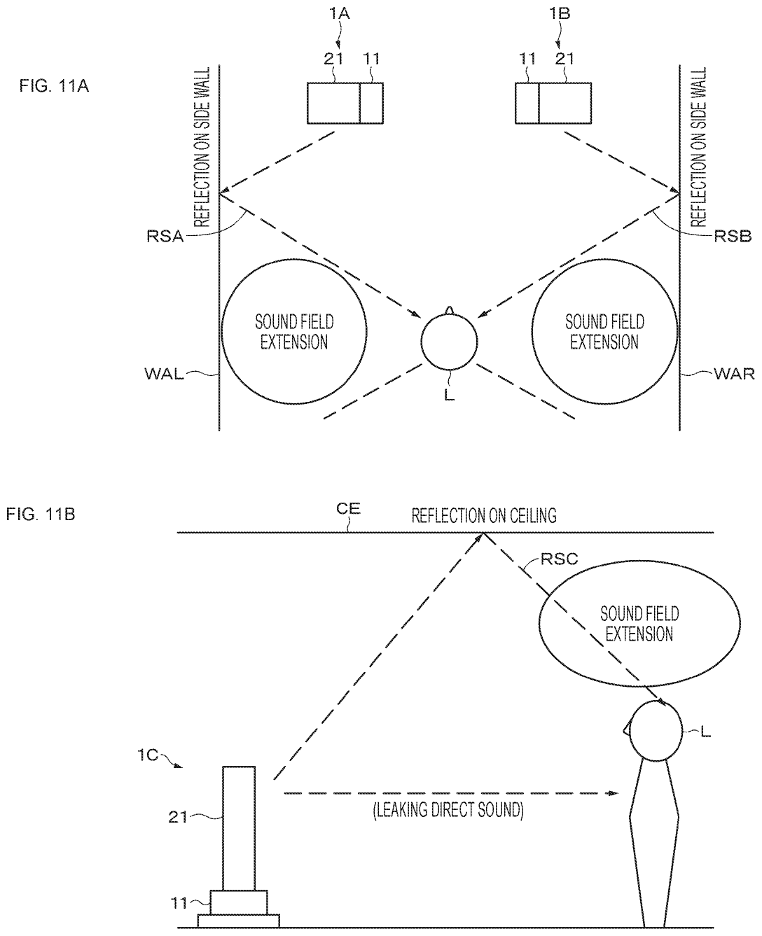

A usage example of the sound reproduction apparatus will be described with reference to FIGS. 11A and 11B. A sound reproduction apparatus in the following description has a configuration similar to the sound reproduction apparatus 1. Note that FIGS. 11A and 11B illustrate the sound reproduction apparatus in a simplified manner.

FIG. 11A illustrates an example in which two sound reproduction apparatuses 1A and 1B are disposed in the left and right directions with respect to the front of a listener L. The sound reproduction apparatuses 1A and 1B are placed horizontally, for example. The sound reproduction apparatus 1A reproduces a high-frequency component such as an audio signal of a left (L) channel, and the sound reproduction apparatus 1B reproduces a high-frequency component such as an audio signal of a right (R) channel.

The sound in the beam generation direction BD from the sound reproduction apparatus 1A is reflected by a wall WAL located on the left side with respect to the listener L and is heard by the listener L as a reflected sound RSA. The sound in the beam generation direction BD from the sound reproduction apparatus 1B is reflected by a wall WAR located on the right side with respect to the listener L and is heard by the listener L as a reflected sound RSB. The listener L can feel the spread of the sound field by listening to the reflected sounds RSA and RSB.

As described above, in the present embodiment, the sound pressure level in the beam generation direction BD can be increased and thus the sound pressure level of the reflected sound can be increased, and therefore the reflection effect can be improved. In addition, the leakage level of the direct sound reaching the listener L from the sound reproduction apparatuses 1A and 1B can be reduced and thus the sound pressure level of the reflected sound can be relatively increased, and therefore the reflection effect can be improved.

FIG. 11B illustrates a usage example in which a sound reproduction apparatus 1C is disposed vertically in front of a listener L. The sound in the beam generation direction BD from the sound reproduction apparatus 1C is reflected by a ceiling CE and is heard by the listener L as a reflected sound RSC. The listener L can feel the spread of the sound field by listening to the reflected sound RSC.

As described above, in the present embodiment, the sound pressure level in the beam generation direction BD can be increased and thus the sound pressure level of the reflected sound can be increased, and therefore the reflection effect can be improved. In addition, the leakage level of the direct sound reaching the listener L from the sound reproduction apparatus 1C can be reduced and thus the sound pressure level of the reflected sound can be relatively increased, and therefore the reflection effect can be improved.

### Modified Examples

Although one embodiment of the present disclosure has been described above, the present disclosure is not limited to the above-described embodiment, and various modifications can be made without departing from the gist of the present disclosure.

In the above-described embodiment, the configuration in which all the holes have an inclination has been described, but a configuration in which some of the holes do not have an inclination (for example, a configuration in which some of the holes open in a direction of 0°) may be employed. For example, a configuration in which holes close to the distal end portion by a predetermined distance or more in the sound reproduction apparatus have no inclination may be employed.

In the above-described embodiment, the configuration in which the holes are provided along two rows of the plate-shaped portion has been described, but the holes may be provided along three or more rows. In this case, the holes provided along the respective rows may be arranged in a staggered manner. In addition, the plurality of holes may be provided so as to form an annular shape or a rectangular shape instead of a row. In addition, although the holes gradually increase in diameter according to the embodiment, the holes may be grouped into units each including a plurality of holes and increase in diameter on a unit-by-unit basis.

In the embodiment described above, the speaker unit and the sound conduit may be directly connected without the connecting portion. In addition, the plate-shaped portion is not limited to a plate-like shape and may have a curved shape or a partially bent shape. The sound conduit 21 may be formed of a light transmissive member or may have a shape other than a cylindrical shape (for example, a quadrangular prism shape or a triangular prism shape). The sound reproduction apparatus 1 may have a configuration other than the configuration described in the embodiment (for example, a support base).

In addition, the items described in each of the embodiment and the modified examples can be combined as appropriate. Furthermore, the content of the present disclosure is not to be construed as being limited by the effects exemplified in the present specification.

The present disclosure may have the following configurations.

(1)

A sound reproduction apparatus including:
a speaker unit; and

a hollow sound conduit having one end side closed and another end side serving as an open end fitted with the speaker unit, in which the sound conduit has a plurality of holes, and the holes each have a shape inclined in a beam generation direction of sound radiated through the plurality of holes.

(2)

The sound reproduction apparatus according to (1), in which the hollow sound conduit includes a wall portion and a plate-shaped portion, and the plurality of holes is provided in the plate-shaped portion.

(3)

The sound reproduction apparatus according to (2), in which in a case where a direction substantially orthogonal to the plate-shaped portion is taken as 0°, an extending direction of the plate-shaped portion toward the speaker unit is taken as −90°, and an extending direction of the plate-shaped portion toward the one end side of the sound conduit is taken as 90°, the beam generation direction ranges from 60° to 90°.

(4)

The sound reproduction apparatus according to (3), in which
the plurality of holes is inclined by approximately 45°.

(5)

The sound reproduction apparatus according to any one of (1) to (4), in which
the plurality of holes is substantially aligned along an extending direction of the sound conduit.

(6)

The sound reproduction apparatus according to (5), in which
a diameter of each of the plurality of holes increases from a side close to the speaker unit toward the one end side.

(7)

The sound reproduction apparatus according to (5) or (6), in which
the plurality of holes includes a first hole group provided substantially aligned with respect to a first row along the extending direction of the sound conduit and a second hole group provided substantially aligned with respect to a second row along the extending direction of the sound conduit, and
individual holes constituting the first hole group and individual holes constituting the second hole group are arranged in a staggered manner.

(8)

The sound reproduction apparatus according to any one of (1) to (4), in which
the speaker unit includes a tweeter unit that reproduces sound in a high frequency range of a predetermined frequency or more.

(9)

The sound reproduction apparatus according to (8), in which
the sound in the high frequency range of the predetermined frequency or more includes a sound of 5 kHz or more.

(10)

The sound reproduction apparatus according to (8) or (9), in which
the speaker unit reproduces a signal passing through a high-pass filter whose cutoff frequency equals the predetermined frequency.

### REFERENCE SIGNS LIST

1 SOUND REPRODUCTION APPARATUS
11 Speaker unit
21 Sound conduit
21A Plate-shaped portion
21B Wall portion
41, 42A, 42B Hole
41A First hole group
41B Second hole group
CA First row
CB Second row
BD Beam generation direction

1. A sound reproduction apparatus comprising:
a speaker unit; and
a hollow sound conduit having one end side closed and another end side serving as an open end fitted with the speaker unit, wherein
the sound conduit has a plurality of holes, and
the holes each have a shape inclined in a beam generation direction of sound radiated through the plurality of holes.

2. The sound reproduction apparatus according to claim 1, wherein
the hollow sound conduit includes a wall portion and a plate-shaped portion, and
the plurality of holes is provided in the plate-shaped portion.

3. The sound reproduction apparatus according to claim 2, wherein
in a case where a direction substantially orthogonal to the plate-shaped portion is taken as 0°, an extending direction of the plate-shaped portion toward the speaker unit is taken as −90°, and an extending direction of the plate-shaped portion toward the one end side of the sound conduit is taken as 90°,
the beam generation direction ranges from 60° to 90°.

4. The sound reproduction apparatus according to claim 3, wherein
the plurality of holes is inclined by approximately 45°.

5. The sound reproduction apparatus according to claim 1, wherein
the plurality of holes is substantially aligned along an extending direction of the sound conduit.

6. The sound reproduction apparatus according to claim 5, wherein
a diameter of each of the plurality of holes increases from a side close to the speaker unit toward the one end side.

7. The sound reproduction apparatus according to claim 5, wherein
the plurality of holes includes a first hole group provided substantially aligned with respect to a first row along the extending direction of the sound conduit and a second hole group provided substantially aligned with respect to a second row along the extending direction of the sound conduit, and
individual holes constituting the first hole group and individual holes constituting the second hole group are arranged in a staggered manner.

8. The sound reproduction apparatus according to claim 1, wherein
the speaker unit includes a tweeter unit that reproduces sound in a high frequency range of a predetermined frequency or more.

9. The sound reproduction apparatus according to claim 8, wherein
the sound in the high frequency range of the predetermined frequency or more includes a sound of 5 kHz or more.

10. The sound reproduction apparatus according to claim 8, wherein
the speaker unit reproduces a signal passing through a high-pass filter whose cutoff frequency equals the predetermined frequency.
